(19) United States
(12) Patent Application Publication
(10) Pub. No.: US 2024/0289770 A1
(43) Pub. Date: Aug. 29, 2024

(54) Blockchain payment method and device

(71) Applicant: ORANGE, Issy-les-Moulineaux (FR)

(72) Inventors: Emmanuel Bertin, CHATILLON CEDEX (FR); Julien Hatin, CHATILLON CEDEX (FR)

(21) Appl. No.: 18/572,515

(22) PCT Filed: Jun. 20, 2022
(86) PCT No.: PCT/FR2022/051189

§ 371 Date: Dec. 20, 2023

(30) Foreign Application Priority Data
Jun. 22, 2021 (FR) FR2106623

(51) Int. Cl. G06Q 20/36; G06Q 20/38

(52) U.S. Cl. CPC G06Q 20/367; G06Q 20/389

(57) ABSTRACT

A payment method implemented by a payment device and including: receiving a first request intended for a computer program, referred to as smart contract, recorded on a blockchain, the first request including at least one electronic token associated with at least one parameter; sending the at least one parameter in response to a second request originating from a service application; and issuing the at least one token in response to a third request originating from the service application.

### 1. FIELD OF THE INVENTION

The invention relates to the general field of telecommunication networks and more particularly to blockchain technology.

### 2. PRIOR ART

As indicated in the document (https://fr.wikipedia.org/wiki/Blockchain), blockchain technology is a technology for storage and transmission of information without a control member. Technically, it is a distributed database in which the information sent by the users and the links internal to the base are verified and grouped together at regular time intervals into blocks, all being secured by cryptography, and thus forming a chain. By extension, a blockchain is a distributed database which manages a list of records protected against falsification or modification by storage nodes; it is therefore a distributed and secured record of all the transactions performed since the system was started. The blockchains are notably characterised in that their contents cannot be modified or deleted: a piece of information that is published (that is to say recorded or saved) in a blockchain remains so for all time. Thus, a blockchain is deemed unalterable and allows the management of sensitive data such as crypto-currencies (currency transmitted peer-to-peer without the intervention of a central bank). The decentralised electronic currency Bitcoin created in 2009 can be cited for example.

As is known, the security of a blockchain lies also in the fact that the transactions performed in the blockchain are visible to all those who have access to this blockchain. This transparency is a fundamental property of the blockchain. Even so, when wanting to use a blockchain to perform financial transactions, this transparency can become a handicap, notably when one of the parties does not want to reveal the amount of the transaction. This is notably the case when a business uses a blockchain to manage, for example via smart contracts, the ordering of goods or of services. Indeed, the confidentiality of the price paid is an important element of the commercial relationship. This confidentiality allows the pricing policy of the provider to be constructed optimally, based on negotiation margins.

A smart contract is a small computer program which makes it possible to perform token transactions under certain conditions. The objective of these smart contracts is to replace the paper contracts by a computer code in order to digitise the procedures.

### 3. SUMMARY OF THE INVENTION

The invention improves on the state-of-the-art and to this end proposes a payment method implemented by a payment device and wherein it comprises:
a step of reception of a first request intended for a computer program, called smart contract, included in a blockchain, said first request comprising at least one electronic token associated with at least one parameter;
a first step of transmission, in response to a second request originating from a service application, of said at least one parameter;
a second step of transmission, in response to a third request originating from said service application, of said at least one token.

Advantageously, this mode of implementation of the invention makes it possible to provide, to a service application, parameters of use of tokens contained in a smart contract in order for the latter to be able to check that the tokens are indeed valid and that they allow the execution of the service. Once the checking has been done and the tokens have been validated, the method transmits, at the request of the service application, the service application tokens.

For example, a business wanting to purchase a service negotiates a price with a service provider. When the parties make the deal, the negotiated price is translated into one or more tokens associated with one or more parameters of use such as the type of access, the access rights, the determination of volume, an execution quota, trade parameters specific to the service, a service identifier, etc. The tokens are then deposited in a smart contract included in a blockchain.

When the business requests the performance of the contract (that is to say the execution of the service) it gives the provider of the service (the service application) the reference of the smart contract containing the tokens. Next, the service provider checks the parameters of the tokens and then, if they are valid, requests the transfer of the tokens before or after the execution of the service. Thus, the negotiated price is not visible to the people who have access to the blockchain and the confidentiality of the price paid necessary for the execution of the service is respected.

It should be noted that the smart contract can be created ephemerally, that is to say for a single transaction or else topped up on demand depending on the services negotiated.

The term blockchain is understood to cover blockchains that are capable of executing dApps. The DApps are decentralised applications that are referred to as such. Non-exhaustive examples that can be cited include: EOS, Hyperledger Burrow, Hyperledger Fabric, Ethereum, Neo, Counterparty, Lisk, etc. In concrete terms, each decentralised application present in the blockchain is composed of a binary code and of an interface setting out the methods that can be invoked, for example by a third party or by other applications. A DApps also has a private data zone that it will be able to modify according to the processing operations performed.

A service application is understood to be computer software developed to be executed on a terminal such as a telephone, a computer, a connected object, a connected vehicle, a tablet, etc., and that allows the execution of a service.

An electronic token is understood to be a unique string of characters and/or of binary data having associated with a certain financial value. An electronic token is, for example, a consumption unit containing no reference to a price. It is, by contrast, linked to parameters of use making it possible to determine the value thereof.

According to a particular embodiment of the invention, a method as described above is characterised in that the reception step is followed by a second step of reception, from a user, of a request authorising the transmission of data by said smart contract.

This embodiment allows increased security. Indeed, for the tokens to be transferred to the service application, the user must first authorise the transaction. This authorisation can for example be done via identifiers or cryptographic keys.

Obviously, the method authorises the transmission of data only if the identifiers and/or the cryptographic keys are valid.

According to a variant of this particular embodiment of the invention, a method as described above is characterised in that the request authorising the transmission of data comprises an identifier of said service application.

This embodiment allows additional security. The authorisation of the transmission of data being only valid for the service application identified by the service application identifier.

According to a particular embodiment of the invention, a method as described above is characterised in that the second transmission step is conditioned by the response to a request transmitted to said user.

This embodiment makes it possible to condition the transmission of the tokens to an agreement of the user (client of the service provided). The validation user can thus be done transaction by transaction. This authorisation can for example be done via identifiers or cryptographic keys. Obviously, the method authorises the transmission of tokens only if the identifiers and/or the cryptographic keys are valid.

According to a particular embodiment of the invention, a method as described above is characterised in that the second transmission step is followed by a third step of transmission of data comprising at least one identifier of said service application and said at least one token.

This embodiment makes it possible to obtain transaction information, that is to say the tokens used for a given service application, for example for the establishment of invoices or statistics. This can also make it possible to track the consumption/use of the tokens contained in the smart contract.

A service application identifier is understood to be a string of characters and/or of binary data which serves to identify a service application.

According to a particular embodiment of the invention, a method as described above is characterised in that said at least one parameter corresponds at least to a duration or to a schedule. This embodiment allows the service provider to check that the conditions of execution of the service do indeed conform to that which has been negotiated in terms of duration or schedule for execution.

According to a particular embodiment of the invention, a method as described above is characterised in that said at least one parameter corresponds at least to a quota of execution of a service by said service application.

This embodiment allows the service provider to check that the conditions of execution of the service do indeed conform to what has been negotiated in terms of quota of service execution.

According to a particular embodiment of the invention, a method as described above is characterised in that the quantity of tokens transmitted in the second transmission step corresponds to a number of tokens included in the third request.

This embodiment allows the service provider to specify the number of tokens to be transferred for the execution of the service. This for example makes it possible to take account of a change of pricing scale on the part of the service provider with an adjustment of the consumption of the tokens for the execution of the service.

According to a particular embodiment of the invention, a method as described above is characterised in that said at least one token obtained in the reception step is further associated with a service identifier and in that:
said at least one parameter transmitted in the first transmission step is a function of a second identifier obtained from said second request;
said at least one token transmitted in the second transmission step is a function of a third identifier obtained from said third request.

This embodiment for example makes it possible to manage and distinguish in one and the same smart contract the tokens of different services, each token being associated with a service identifier (that is to say with a service application which provides the service concerned). To do this, when the service application interrogates the smart contract, the latter provides its identifier. The method can then sort the tokens contained in the smart contract as a function of the received identifier and return to the service application only the tokens or the parameters associated with the tokens deposited in the smart contract for this service.

A service identifier is understood to be a string of characters and/or of binary data which serves to identify a service.

The invention relates also to a payment device characterised in that it comprises:
a module for reception of a first request intended for a computer program, called smart contract, included in a blockchain, said first request comprising at least one electronic token associated with at least one parameter;
a first module for transmission, in response to a second request originating from a service application, of said at least one parameter;
a second module for transmission, in response to a third request originating from said service application, of said at least one token.

The invention relates also to a blockchain characterised in that it comprises a payment device as described previously.

The term module can correspond equally to a software component and to a hardware component or a set of hardware and software components, a software component itself corresponding to one or more computer programs or sub-programs or, more generally, to any element of a program capable of implementing a function or a set of functions as described for the modules concerned. Likewise, a hardware component corresponds to any element of a hardware set (or simply hardware) capable of implementing a function or a set of functions for the module concerned (integrated circuit, chip card, memory card, etc.).

The invention relates also to a computer program comprising instructions for the implementation of the above method according to any one of the particular embodiments described previously, when said program is run by a processor. The method can be implemented in various ways, notably in hardwired form or in software form. This program can use any programming language, and be in the form of source code, object code, or intermediate code between source code and object code, such as in a partially compiled form, or in any other desirable form.

The invention also targets a computer-readable storage medium or information medium, comprising instructions of a computer program as mentioned above. The abovementioned storage media can be any entity or device capable of storing the program. For example, the medium can comprise a storage means, such as a ROM, for example a CD ROM or a microelectronic circuit ROM, or even a magnetic storage means, for example a hard disk. Also, the storage media can correspond to a transmissible medium such as an electrical or optical signal, which can be conveyed via an electric or optical cable, wirelessly or by other means. The programs according to the invention can in particular be downloaded over a network of Internet type.

Alternatively, the storage media can correspond to an integrated circuit in which the program is incorporated, the circuit being adapted to execute or be used in the execution of the method concerned.

This payment device and this computer program have features and advantages analogous to those described previously in relation to the payment method.

### 4. LIST OF FIGURES

Other features and advantages of the invention will become more clearly apparent on reading the following description of particular embodiments, which are given as illustrative and nonlimiting examples, and of the attached drawings, in which:

FIG. 1 represents the hardware architecture of a payment device according to a particular embodiment;

FIG. 2 represents, in flow diagram form, the main steps of a payment method that conform to the embodiments of the invention.

### 5. DESCRIPTION OF AN EMBODIMENT OF THE INVENTION

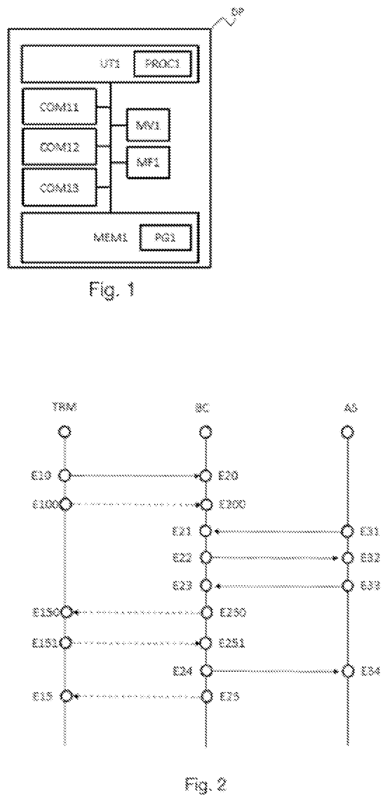

FIG. 1 represents the hardware architecture of a payment device DP to one that conforms to the invention. In the embodiment described here, this device has the hardware architecture of a computer. It notably comprises a processor PROC1, a random-access memory MV1, a read-only memory MEM1 and a non-volatile flash memory MF1. Such means are known per se and are not described in more detail here. The read-only memory constitutes a storage medium that conforms to the invention, that can be read by the processor PROC1 and on which is stored here a computer program PG1 that conforms to the invention, this program comprising instructions for implementing the steps of the payment method as described previously, when the program is run by the processor PROC1.

On initialisation, the code instructions of the computer program PG1 are for example loaded into a memory before being executed by the processor PROC1. The processor PROC1 of the processing unit UT1 notably implements the steps of the payment method according to any one of the particular embodiments described in relation to FIG. 2, according to the instructions of the computer program PG1.

The device DP also comprises communication modules COM11, COM12 and COM13 which are configured to establish communications an IP with, for example, network and/or circuit. The communication module COM11 is used to receive requests intended for a smart contract included in a blockchain, the module COM12 is used to transmit, in response to a request originating from a service application, parameters associated with the tokens contained in the smart contract and the module COM13 is used to transmit tokens in response to a request originating from a service application.

According to a particular embodiment of the invention, the modules COM11, COM12 and COM13 can be one and the same communication module (COM1).

According to a particular embodiment of the invention, the module COM1 can also be used to transmit data comprising at least one identifier of said service application and tokens intended for a user of a terminal.

According to a particular embodiment of the invention, the module COM1 can also receive authorisation requests and transmit authorisation requests concerning the transmission of data.

Referring to FIG. 2, there now follows a description of the main steps of a payment method according to a particular embodiment of the invention.

FIG. 2 is composed of a terminal TRM such as, for example, a mobile terminal or a computer capable of transmitting and/or receiving requests to and from a blockchain. FIG. 2 is also composed of a blockchain BC capable of executing decentralised functions or DApps within the meaning of blockchain technology. In the case described in support of FIG. 2, the blockchain BC is able to execute a smart contract, that is to say a DApps, and the payment method according to the invention. The payment method is for example executed by a dedicated DApps.

According to a particular embodiment of the invention, the payment method is executed outside of the blockchain, for example via a terminal (computer, mobile, etc.) connected and authenticated with the blockchain BC.

FIG. 2 further comprises a service application AS capable of executing a particular service. The service application is for example executed by a server, a mobile terminal, a home gateway, a connected object or, more generally, a terminal having the hardware architecture of a computer.

The terminal TRM, the blockchain and the service application communicate with one another via, for example, an IP network and/or a public network (for example the Internet network) or private network.

During a first step E10, the terminal TRM sends an execution request to the smart contract included in the blockchain. The request comprises one or more tokens and one or more parameters associated with the tokens.

According to a particular embodiment of the invention, the request can also comprise an identifier of the terminal TRM and/or a user identifier and/or cryptographic keys making it possible for example for the blockchain to authenticate the terminal TRM or the user of the terminal TRM. Obviously, it is assumed that the terminal TRM and its user are already known and registered in the blockchain.

Alternatively or in addition, the request can further comprise a service identifier and/or service application identifier associated with the tokens.

In the step E20 the request is received by the blockchain BC. The tokens associated with their parameters and optionally with a service identifier are added in the smart contract included in the blockchain BC.

In the step E21 the payment method receives a request for parameters transmitted (E31) by the service application AS. In response to this request, the payment method transmits (E22) the parameters associated with the tokens contained in the smart contract.

According to a particular embodiment of the invention, the request received by the method can further comprise a service identifier and/or service application identifier. Next, the method obtains, from the smart contract, the tokens associated with service identifier and/or service application identifier and then transmits, in the step E22, the parameters associated with the tokens obtained intended for the service application AS. This embodiment makes it possible to have, in the smart contract, tokens intended for different service applications AS or for different services managed by the same service application.

In the step E32, the service application AS checks that the parameters received do indeed correspond to what has been negotiated with the client, that is to say the user of the terminal TRM, for the execution of the service. In concrete terms, it checks that the duration and/or the number of executions and/or the execution schedules do indeed conform to the contract. The service application AS can also check that the number of tokens contained in the smart contract is sufficient for the execution of the service.

According to a particular embodiment of the invention, the service application AS can execute the service if the parameters received are valid.

According to a particular embodiment of the invention, the service application AS can, as a function of the parameters received, calculate a number of tokens necessary for the execution of the service.

In the step E33, the service application AS transmits, to the method, a request for the transmission of tokens. The method receives the request (E23) then sends in return the tokens to the service application. It should be noted that, in the case of a prepayment model, the reception of the tokens by the service application (E34) can be a prerequisite for the execution of the service. Conversely, the service application can execute the service in the step E33, that is to say before the tokens are transferred.

According to a particular embodiment of the invention, the token request can comprise a service identifier or service application identifier. This embodiment makes it possible for the method to obtain and send to the service application only the tokens which are intended for it.

According to a particular embodiment of the invention, the method can, at the end of the step E20, receive, in the step E200, an authorisation request transmitted by the terminal TRM (E100). This request allows the user to authorise the method to transmit data such as the tokens and/or their associated parameters. In concrete terms, the terminal TRM sends to the method, with the authorisation request, authentication data such as identifiers and/or cryptographic keys (private and/or public) allowing the method to identify the user and/or the terminal. When the user and/or the terminal TRM is identified/authenticated by the method, the method allows the sending of data by the smart contract. This embodiment allows the activation of the smart contract. The security thereof is reinforced because no transaction can be performed by the smart contract without this prior activation.

According to a particular embodiment of the invention, the steps E10 to E34 are performed a plurality of times. It is thus possible to use the smart contract several times in order to execute one or more services a plurality of times.

According to a variant of this embodiment, the authorisation request further comprises a service identifier and/or service application identifier. Thus, by virtue of this embodiment, it is possible to authorise or not authorise the transmission of data by the smart contract, service by service or service application by service application.

According to a particular embodiment of the invention, the method can, at the end of the step E23, transmit, to the terminal TRM, an authorisation request (E250). This request is then received by the terminal TRM in the step E150. The terminal TRM transmits in return (E151) a response which is received by the method in the step E251. In concrete terms, the terminal TRM can send to the method, in response to the authorisation request, a parameter validating the authorisation request and authentication data such as identifiers and/or cryptographic keys (private and/or public) allowing the method to identify the user and/or the terminal TRM. When the user and/or the terminal TRM is identified/authenticated by the method, the method allows the sending of data by the smart contract. This embodiment allows the user to validate each transaction and thus control the transmission of the tokens (E24) by the smart contract.

According to a particular embodiment of the invention, the step E24 is followed by a step of transmission E25, to the terminal TRM, of data comprising at least the tokens transmitted in the step E24 to the service application and an identifier of the service application. Thus it is possible for the user of the terminal TRM to track the consumption of the tokens, for example to establish an invoice or automate the accounting procedures.

1. A payment method implemented by a payment device and wherein the method comprises:
receiving a first request intended for a computer program, called smart contract, included in a blockchain, said first request comprising at least one electronic token associated with at least one parameter;
a first act of transmitting, in response to a second request originating from a service application, said at least one parameter; and
a second act of transmitting, in response to a third request originating from said service application, said at least one token.

2. The payment method as claimed in claim 1, wherein the receiving is followed by a second act of receiving, from a user, of a request authorising the transmission of data by said smart contract.

3. The payment method as claimed in claim 2, wherein the request authorising the transmission of data comprises an identifier of said service application.

4. The payment method as claimed in claim 1, wherein the second act of transmitting is conditioned by a response to a request transmitted to said user.

5. The payment method as claimed in claim 1, wherein the second act of transmitting is followed by a third act of transmitting data comprising at least one identifier of said service application and said at least one token.

6. The payment method as claimed in claim 1, wherein said at least one parameter corresponds at least to a duration or to a schedule.

7. The payment method as claimed in claim 1, wherein said at least one parameter corresponds at least to a quota of execution of a service by said service application.

8. The payment method as claimed in claim 1, wherein a quantity of tokens transmitted in the second act of transmitting corresponds to a number of tokens included in the third request.

9. The payment method as claimed in claim 1, wherein said at least one token obtained in the receiving is further associated with a service identifier and wherein:
said at least one parameter transmitted in the first act of transmitting is a function of a second identifier obtained from said second request;
said at least one token transmitted in the second act of transmitting is a function of a third identifier obtained from said third request.

10. A payment device, wherein it the payment device comprises:
at least one processor; and
at least one computer readable medium comprising instructions stored thereon which when executed by the at least one processor configure the payment device to:
receiving a first request intended for a computer program, called smart contract, included in a blockchain, said first request comprising at least one electronic token associated with at least one parameter;
transmit, in response to a second request originating from a service application, of said at least one parameter; and
transmit, in response to a third request originating from said service application, of said at least one token.

11. A non-transitory computer readable medium comprising a computer program stored thereon comprising instructions for implementing a payment method, when the program is run by a processor of a payment device, wherein the payment method comprises:
receiving a first request intended for a computer program, called smart contract, included in a blockchain, said first request comprising at least one electronic token associated with at least one parameter;
transmitting, in response to a second request originating from a service application, said at least one parameter; and
transmitting, in response to a third request originating from said service application, said at least one token.
